(19) United States
(12) Patent Application Publication
(10) Pub. No.: US 2012/0024467 A1
(43) Pub. Date: Feb. 2, 2012

(54) Protecting surfaces and frangible structures

(75) Inventor: Andrew Harry Orchard, Exeter (GB)

(73) Assignee: Packexe (Holdings) Limited

(21) Appl. No.: 12/804,878

(22) Filed: Jul. 29, 2010

(51) Int. Cl. B29C 65/48

(52) U.S. Cl. 156/238; 156/459

(57) ABSTRACT

A method of protecting a surface, such as the surface of a windscreen of a motor vehicle, comprises providing a cylindrical roll of a plastic film one side of which has an adhesive coating afforded by a solvent-based acrylic adhesive and in which the plastic film is formed with a plurality of spaced transversely extending rows of perforations, applying the adhesive-coated side of the plastic film to the surface or structure using two spaced resilient rollers, unwinding a desired length of the plastic film from the roll and rupturing the plastic film along a selected row of perforations.

### FIELD OF THE INVENTION

This invention relates to the protection of surfaces and frangible structures.

One of the problems faced by firemen attending crash scenes involving motor vehicles is that, when attempting to gain access to the interior of a vehicle in which one or more people are trapped by cutting through part of the vehicle structure, they may cause breakage of one or more windows of the vehicle.

The breaking of a vehicle window can result in shattering of the glass, with the possibility of injuring one or more of the firemen and/or one or more of the people within the vehicle.

It is accordingly an object of the present invention to provide an effective answer to the above problem.

A more general object of the present invention is to provide an improved method of protecting surfaces and frangible structures.

### SUMMARY OF THE INVENTION

According to a first aspect of the present invention there is provided a method of protecting a surface or structure which comprises providing a cylindrical roll of a plastic film one side of which has an adhesive coating afforded by a solvent-based acrylic adhesive and in which the plastic film is formed with a plurality of spaced transversely extending rows of perforations, applying the adhesive-coated side of the plastic film to the surface or structure using two spaced resilient rollers, unwinding a desired length of the plastic film from the roll and rupturing the plastic film along a selected row of perforations.

The roll of plastic film is preferably wound onto a core that is rotatably supported by a pair of end caps that provide support for the resilient rollers that extend parallel to the axis of rotation of the core and enables the user to apply a resilient load to the plastic film as it is being applied to the surface or structure. The purpose of this is to ensure that complete, strong, uniform contact is obtained between the plastic film and the surface or structure.

The two spaced resilient rollers are preferably supported by the end caps and facilitate rupturing of the film along the selected row of perforations.

The plastic film may be low density polyethylene having a thickness within the range of from 40 to 100 microns, typically between 50 to 60 microns. The rows of perforations may be spaced apart by a distance of the order of 50 to 150 mms., typically 100 mms.

According to a second aspect of the present invention there is provided a dispenser for use in protecting a surface or structure, the dispenser comprising a core supported between a pair of end caps, a cylindrical roll of a plastic film wound onto the core, one side of the film having an adhesive coating afforded by a solvent-based acrylic adhesive and the plastic film being formed with a plurality of spaced transversely extending rows of perforations, and two spaced resilient rollers that extend parallel to the axis of rotation of the core and enable the user to apply a resilient load to the plastic film as it is being applied to the surface or structure.

### BRIEF DESCRIPTION OF THE FIGURES

FIG. 1 is a schematic sectional side view showing the application of a plastic film to a vehicle window,

FIG. 2 is a perspective view of a dispenser, and

FIG. 3 shows part of a sheet of protective plastic film.

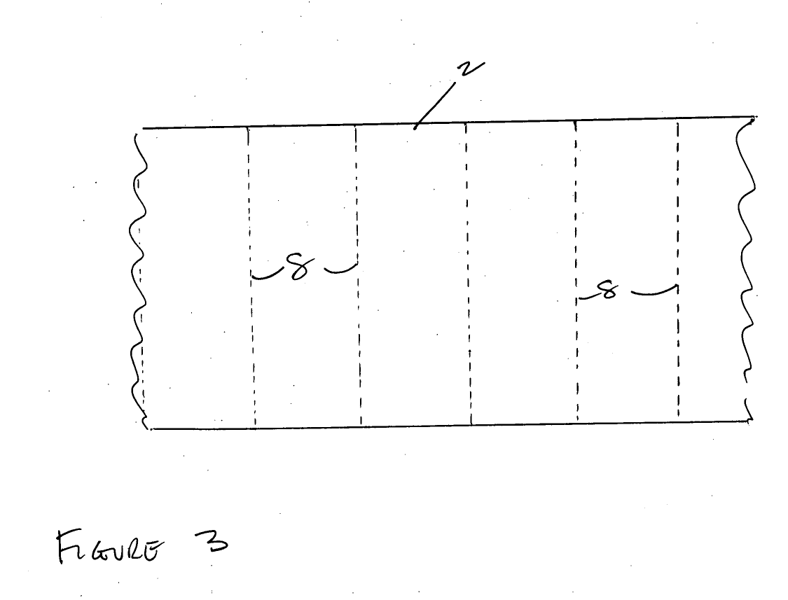

### DESCRIPTION OF THE PREFERRED EMBODIMENT

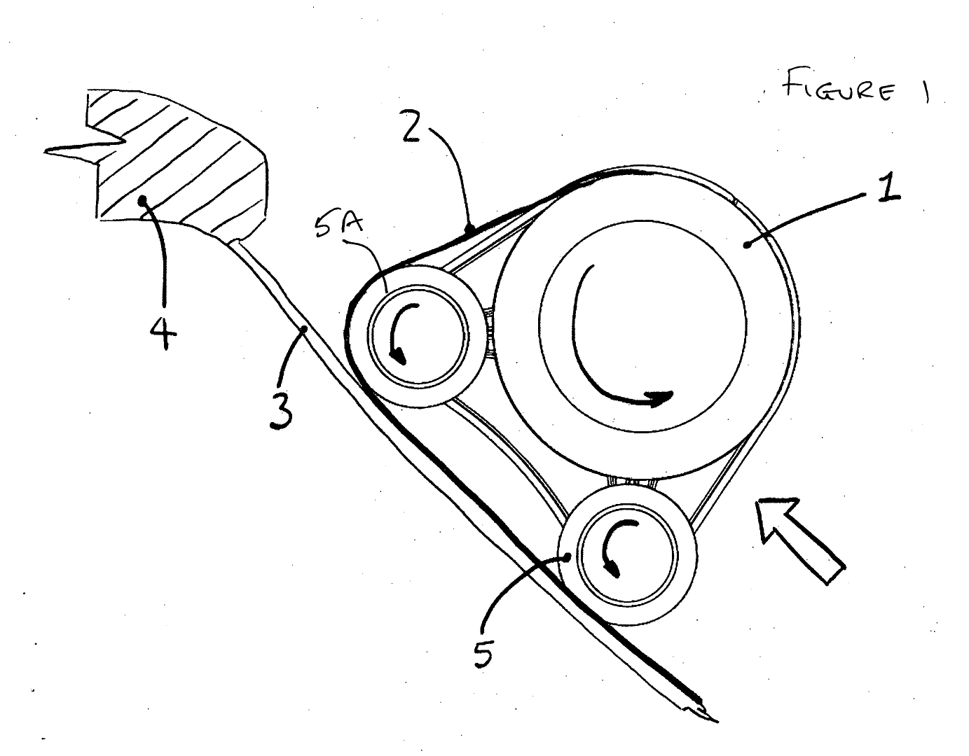

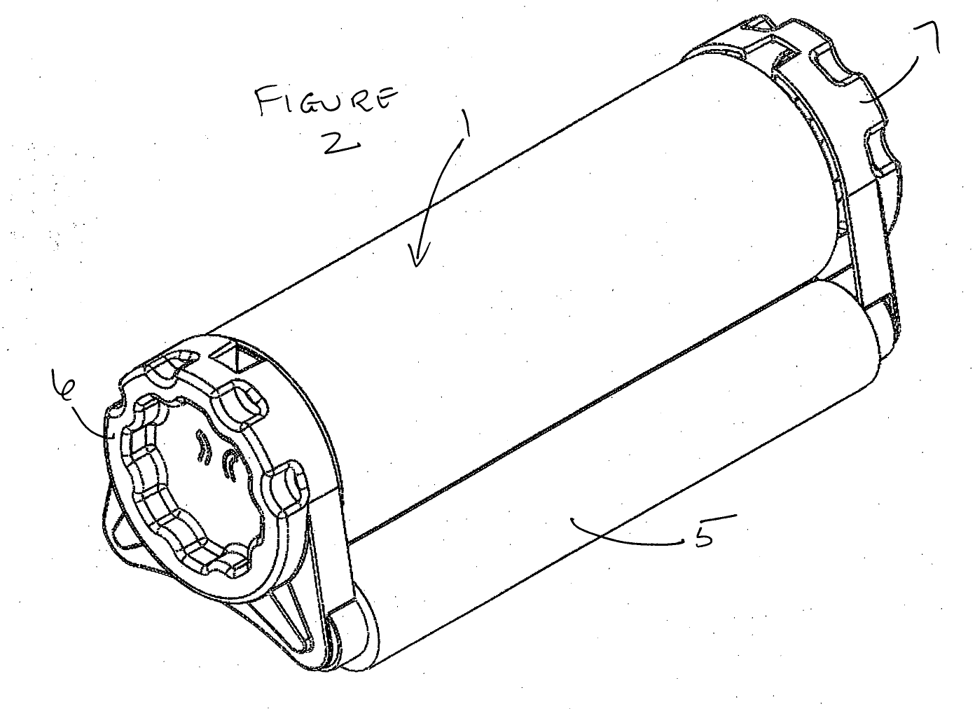

The dispenser shown in FIGS. 1 and 2 comprises a pair of end caps 6 and 7 between which a core 1 is rotatably mounted with a roll of low density polyethylene film 2 wound onto the core 1.

The polyethylene film has an average thickness of the order of 55 microns, a longitudinal tensile strength in excess of 1 daN/cm and a transverse tensile strength in excess of 0.7 daN/cm.

The polyethylene film 2 is a clear film which is coated on one side with a solvent-based acrylic adhesive so that, as the film is withdrawn from the roll, it can be placed on a surface that requires protection and will remain in contact with that surface. The adhesion to steel is of the order of 330 cN/cm.

A pair of resilient rollers 5 and 5A, in the form of cylinders of foamed plastic material supported on central rods, extend between the end caps 6 and 7. The resilient rollers 5 and 5A are spaced from the surface of the polyethylene film 2 wound onto the core 1 and are used to assist in placing the film 2 in the required position and urging it resiliently into contact with the surface to be protected. The film 2 is highly static and this ensures that the non-adhesive side of the film 2 sticks to the rollers 5 and 5A.

The polyethylene film 2 is formed with transversely extending rows 8 of perforations and, when a sufficient length of the polyethylene film 2 has been withdrawn from the roll, the film 2 is ruptured by tearing along a selected row 8 of perforations. The provision of the resilient rollers 5 and 5A facilitates tearing. The rows 8 of perforations extend fully across the film and are typically uniformly spaced apart by a distance of the order of 100 mms. The spacing may alternatively be 50 mms, but could be as much as 150 mms. This close spacing of the rows of perforations makes tearing easier enabling an accurate tear to be made without the need for a separate cutting tool and avoiding wastage of the film 2.

FIG. 1 shows the application of a strip of film 2 to a window or windscreen 3 of a vehicle having a solid frame 4 so as to cover the frangible part of the vehicle. A number of strips of film will normally be applied, starting from a position either above or below the window. The whole of the window or windscreen will be covered with a degree of overlap onto the vehicle frame 4. The film 2 adheres securely to the surfaces to which it is applied. This ensures that, if the window or windscreen 3 should break as a result of an attempt being made to obtain access to the interior of the vehicle, the broken glass will remain adhered to the plastic film 2 and will not injure the firemen or the people within the vehicle.

The technical data for the film may be as follows:—

| | |
|---|---|
| Film Type | Low Density Polyethylene, |
| Average Thickness | 55 Microns, |
| Colour | Clear with Red Print, |
| Adhesive Type | Acrylic Solvent based, |
| Adhesion to Steel | 330 cN/cm., |
| Longitudinal Tensile Strength | >1 daN/cm., |
| Transverse Tensile Strength | >0.7 daN/cm. |

Although specific reference has been made above to the application of the adhesive-coated film to a vehicle window or windscreen, it is to be appreciated that the invention is applicable to the protection of surfaces and structures generally.

1. A method of protecting a surface or structure which comprises providing a cylindrical roll of a plastic film one side of which has an adhesive coating afforded by a solvent-based acrylic adhesive and in which the plastic film is formed with a plurality of spaced transversely extending rows of perforations, applying the adhesive-coated side of the plastic film to the surface or structure using two spaced resilient rollers, unwinding a desired length of the plastic film from the roll and rupturing the plastic film along a selected row of perforations.

2. A method as claimed in claim 1, in which the roll of plastic film is wound onto a core that is rotatably supported by a pair of end caps.

3. A method as claimed in claim 2, in which the end caps provide support for the resilient rollers.

4. A method as claimed in claim 1, in which the plastic film is low density polyethylene having a thickness within the range of from 40 to 100 microns.

5. A method as claimed in claim 4, in which the thickness of the film is between 50 to 60 microns.

6. A method as claimed in claim 1, in which the rows of perforations are spaced apart by a distance of the order of 75 to 150 mms.

7. A dispenser for use in protecting a surface or structure, the dispenser comprising a core supported between a pair of end caps, a cylindrical roll of a plastic film wound onto the core, one side of the film having an adhesive coating afforded by a solvent-based acrylic adhesive and the plastic film being formed with a plurality of spaced transversely extending rows of perforations, and two spaced resilient rollers that enable the user to apply a resilient load to the plastic film as it is being applied to the surface or structure.

8. A dispenser as claimed in claim 7, in which the plastic film is low density polyethylene having a thickness within the range of from 40 to 100 microns.

9. A dispenser as claimed in claim 7, in which the thickness of the film is between 50 to 60 microns.

10. A dispenser as claimed in claim 7, in which the rows of perforations are spaced apart by a distance of the order of 75 to 150 mms.
